(19) United States
(12) Patent Application Publication
(10) Pub. No.: US 2025/0073119 A1
(43) Pub. Date: Mar. 6, 2025

(54) Multi-directional Massage Output Device

(71) Applicant: Wenzhou Xiaotaoqi Trading Co.,Ltd, Wenzhou (CN)

(72) Inventor: Hailun Zhu, Wenzhou (CN)

(21) Appl. No.: 18/951,408

(22) Filed: Nov. 18, 2024

(30) Foreign Application Priority Data
Sep. 23, 2024 (CN) 202422321723.3

(51) Int. Cl. A61H 23/02; A61H 7/00

(52) U.S. Cl. CPC A61H 23/0254; A61H 7/007; A61H 2201/0153; A61H 2201/1207; A61H 2201/1436; A61H 2201/1673

(57) ABSTRACT

Disclosed is a multi-directional massage output device, including a grip handle, wherein the grip handle is provided with an output seat, the grip handle is provided with a driving motor, and an output end of the driving motor is connected to a connecting member. The connecting member includes a connecting portion and an inclined crank arm, the crank arm is connected to the output seat, and the connecting portion is connected to an output end of a first driving member. The multi-directional massage output device is simple in structure, capable of realizing multi-directional output and improving the user experience, and excellent in usage effect.

### TECHNICAL FIELD The present disclosure relates to a multi-directional massage output device.

### BACKGROUND

In order to maintain physical health, both traditional Chinese medicine practitioners and Western medicine practitioners recommend simple massage therapy after daily work to promote relaxation. However, in daily life, it is not always feasible to frequently visit therapy centers or other massage parlors. As a result, consumers often buy simple therapy devices for regular use. However, massage devices currently available on the market have single functions, offering only unidirectional output, which leads to a poor usage effect and negatively affects the consumer experience.

### SUMMARY

To overcome the disadvantages in the prior art, the present disclosure provides a multi-directional massage output device, which is simple in structure, capable of realizing multi-directional output and improving the user experience, and excellent in usage effect.

To achieve the above purpose, the present disclosure provides a multi-directional massage output device, including a grip handle, where the grip handle is provided with an output seat, a driving motor is provided on the grip handle, an output end of the driving motor is connected to a connecting member, the connecting member includes a connecting portion and an inclined crank arm, the crank arm is connected to the output seat, and the connecting portion is connected to an output end of a first driving member.

The beneficial effects of such an arrangement is that, through such an arrangement, by holding the grip handle, the output seat can be operated to work through a control circuit and a corresponding system. The control circuit and the system here are the prior art, which will not be described in detail here. The output seat can be driven by the driving motor to rotate, thereby realizing multi-directional rotation output. Preferably, components such as a vibrator or a kneading hand can be provided on the output seat to perform massaging and kneading output, thereby performing relaxation and therapy treatment on a corresponding part of the body where the output seat is placed. The multi-directional massage output device is simple in structure and capable of realizing multi-directional output and enhancing the structure adaptability. Additionally, the simple structure is easy to implement and excellent in usage effect.

As a further arrangement of the present disclosure, the grip handle is provided in an S-shape, and the output seat is provided at an end of the grip handle.

The beneficial effect of such an arrangement is that, through such an arrangement, the output end can perform rotational massage more accurately, achieving an excellent usage effect.

As a further arrangement of the present disclosure, the grip handle is provided in an S-shape, the output seat is positioned in the middle of the grip handle, a connecting seat is provided at an end of the grip handle, and a vibration component is provided in the connecting seat.

The beneficial effect of such an arrangement is that, through such an arrangement, an output part is added to further improve the massage output effect, and additionally, by positioning the output seat at a middle position, the overall use reliability of the structure is enhanced. The user experience is improved, thereby achieving an excellent usage effect.

As a further arrangement of the present disclosure, the connecting seat extends toward an output shaft, and a spacing groove is formed between the output seat and the connecting seat.

The beneficial effect of such an arrangement is that, through such an arrangement, a spacing groove is formed between the output seat and the connecting seat, which allows for clamping certain body parts and performing rotational massage therapy, thereby enhancing the massage and therapy effect and achieving an excellent massage experience.

As a further arrangement of the present disclosure, the connecting member and the crank arm are connected via a transition block, and the transition block is provided as a spherical fan shape.

The beneficial effect of such an arrangement is that, through such an arrangement, the rotation output of the structure is more stable and comfortable, and the situation of getting stuck is less likely to occur; a central included angle of the spherical fan here is set to be less than 45° to ensure that an inclination angle of the crank arm is within a suitable range and ensure the rotation output effect; and at the same time, the structure is simple, production and manufacturing are convenient and fast, and the user experience is effectively improved.

As a further arrangement of the present disclosure, a vibration component is provided in each of the output seat and the connecting seat.

The beneficial effect of such an arrangement is that, through such an arrangement, the massage output effect is further improved, so that the effect of relaxation and therapy is better, and the overall effectiveness is improved; in addition, the structure is reliable in configuration; and the vibration components are provided, respectively, so that mutual interference can be avoided, improving the effectiveness of the structure, thereby allowing a user to experience an excellent usage effect.

As a further arrangement of the present disclosure, the vibration component includes a mounting seat, a vibration motor, and a mass block, the mounting seat is correspondingly provided in the connecting seat and the output seat, the vibration motor is provided on the mounting seat, and an output end of the vibration motor is connected to the mass block.

The beneficial effect of such an arrangement is that, through such an arrangement, the structure is simple, vibration output is reliable, and installation is stable, facilitating modular production and assembly, thereby improving production and manufacturing efficiency and achieving an excellent usage effect.

As a further arrangement of the present disclosure, outer walls of the connecting seat, the grip handle and the output seat are covered with a continuous soft cushion.

The beneficial effect of such an arrangement is that, through such an arrangement, the overall comfort of the structure during use is enhanced, the usage effect is improved, and the simple structure is easy to implement.

As a further arrangement of the present disclosure, a surrounding frame is provided in the grip handle, and the driving motor is provided in the surrounding frame.

The beneficial effect of such an arrangement is that, through such an arrangement, the position stability of the driving motor is ensured, preventing the structure from deviating due to vibrations, thereby improving the usage reliability of the structure.

### BRIEF DESCRIPTION OF DRAWINGS

FIG. 1 is a cross-sectional structural schematic view of a first embodiment of the present disclosure;

FIG. 2 is a cross-sectional structural schematic view of a second embodiment of the present disclosure; and

FIG. 3 is a structural schematic view of a connecting member in an embodiment of the present disclosure.

### DETAILED DESCRIPTION

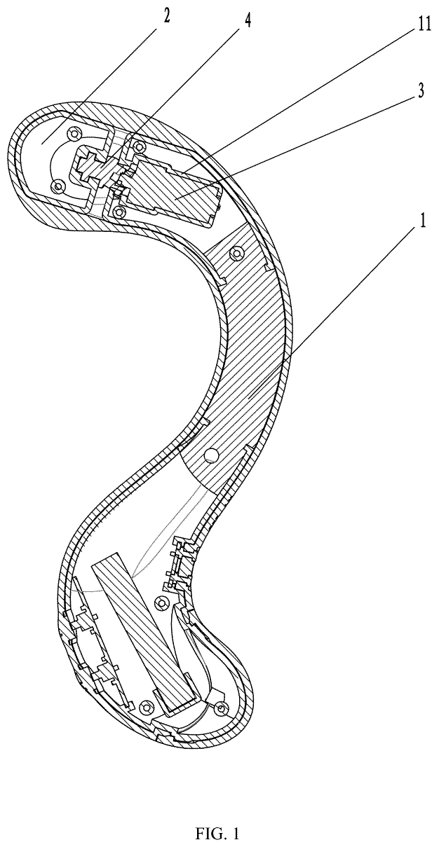

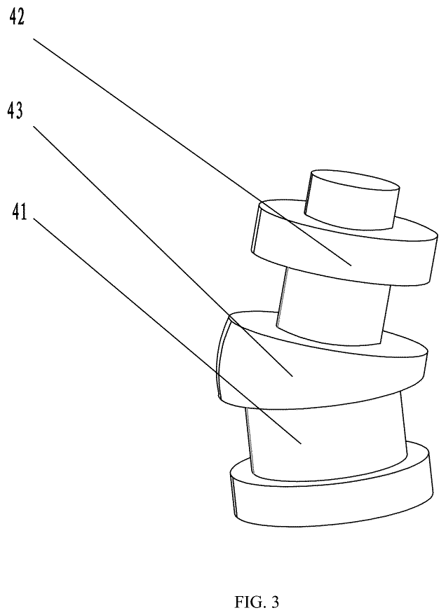

As shown in FIG. 1 and FIG. 3, a first embodiment of a multi-directional massage output device of the present disclosure includes a grip handle 1. The grip handle 1 is provided with an output seat 2, a driving motor 3 is provided on the grip handle 1, an output end of the driving motor 3 is connected to a connecting member 4, the connecting member 4 includes a connecting portion 41 and an inclined crank arm 42, the crank arm 42 is connected to the output seat 2, and the connecting portion 41 is connected to an output end of the driving motor 3. The beneficial effects of such an arrangement is that, through such an arrangement, by holding the grip handle 1, the output seat 2 can be operated to work through a control circuit and a corresponding system. The control circuit and the system here are the prior art, which will not be described in detail here. The output seat 2 can be driven by the driving motor 3 to rotate, thereby realizing multi-directional rotation output. Preferably, components such as a vibrator or a kneading hand can be provided on the output seat 2 to perform massaging and kneading output, thereby performing relaxation and therapy treatment on a corresponding part of the body where the output seat 2 is placed. The multi-directional massage output device is simple in structure and capable of realizing multi-directional output and enhancing the structure adaptability. Additionally, the simple structure is easy to implement and excellent in usage effect.

As a further arrangement of this embodiment, the grip handle 1 is provided in an S-shape, and the output seat 2 is provided at an end of the grip handle 1. The beneficial effect of such an arrangement is that, through such an arrangement, the output end can perform rotational massage more accurately, achieving an excellent usage effect.

As a further arrangement of this embodiment, the connecting member 4 and the crank arm 42 are connected via a transition block 43, and the transition block 43 is provided as a spherical fan shape. The beneficial effect of such an arrangement is that, through such an arrangement, the rotation output of the structure is more stable and comfortable, and the situation of getting stuck is less likely to occur; a central included angle of the spherical fan here is set to be less than 45° to ensure that an inclination angle of the crank arm 42 is within a suitable range, and ensure the rotation output effect; and at the same time, the structure is simple, production and manufacturing are convenient and fast, and the user experience is effectively improved.

As a further arrangement of this embodiment, a surrounding frame 11 is provided in the grip handle 1, and the driving motor 3 is provided in the surrounding frame 11. The beneficial effect of such an arrangement is that, through such an arrangement the position stability of the driving motor 3 is ensured, preventing the structure from deviating due to vibrations, thereby improving the usage reliability of the structure.

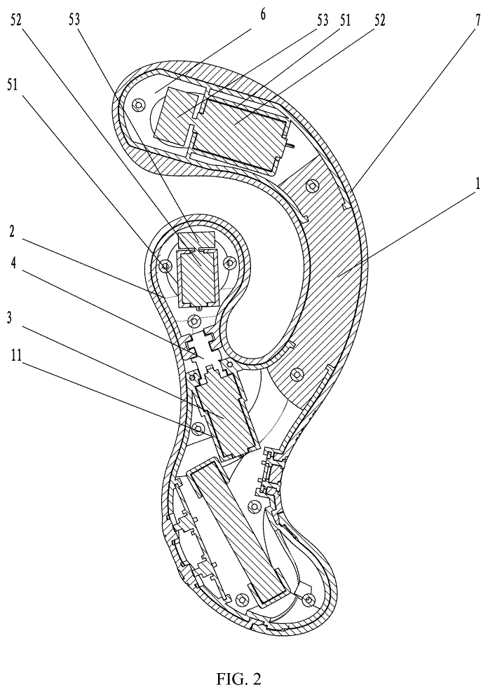

As shown in FIG. 2 and FIG. 3, a second embodiment of the multi-directional massage output device of the present disclosure includes a grip handle 1, where the grip handle 1 is provided with an output seat 2, a driving motor 3 is provided on the grip handle 1, an output end of the driving motor 3 is connected to a connecting member 4, the connecting member 4 includes a connecting portion 41 and an inclined crank arm 42, the crank arm 42 is connected to the output seat 2, and the connecting portion 41 is connected to an output end of the driving motor 3. The beneficial effects of such an arrangement is that, through such an arrangement, by holding the grip handle 1, the output seat 2 can be operated to work through a control circuit and a corresponding system. The control circuit and the system here are the prior art, which will not be described in detail here. The output seat 2 can be driven by the driving motor 3 to rotate, thereby realizing multi-directional rotation output. Preferably, components such as a vibrator or a kneading hand can be provided on the output seat 2 to perform massaging and kneading output, thereby performing relaxation and therapy treatment on a corresponding part of the body where the output seat 2 is placed. The multi-directional massage output device is simple in structure and capable of realizing multi-directional output and enhancing the structure adaptability. Additionally, the simple structure is easy to implement and excellent in usage effect.

The grip handle 1 is provided in an S-shape, the output seat 2 is positioned in the middle of the grip handle, a connecting seat 6 is provided at an end of the grip handle 1, and a vibration component is provided in the connecting seat. The beneficial effect of such an arrangement is that, through such an arrangement, an output part is added to further improve the massage output effect, and additionally, by positioning the output seat 2 at a middle position, the overall use reliability of the structure is enhanced. The user experience is improved, thereby achieving an excellent usage effect.

As a further arrangement of this embodiment, the connecting seat 6 extends toward an output shaft, and a spacing groove is formed between the output seat 2 and the connecting seat 6. The beneficial effect of such an arrangement is that, through such an arrangement, a spacing groove is formed between the output seat 2 and the connecting seat 6, which can allow for clamping certain body parts and performing rotational massage therapy, thereby enhancing the massage and therapy effect and achieving an excellent massage experience.

As a further arrangement of this embodiment, the connecting member 4 and the crank arm 42 are connected via a transition block 43, and the transition block 43 is provided as a spherical fan shape. The beneficial effect of such an arrangement is that, through such an arrangement, the rotation output of the structure is more stable and comfortable, and the situation of getting stuck is less likely to occur; a central included angle of the spherical fan here is set to be less than 45° to ensure that an inclination angle of the crank arm 42 is within a suitable range, and ensure the rotation output effect; and at the same time, the structure is simple, production and manufacturing are convenient and fast, and the user experience is effectively improved.

As a further arrangement of this embodiment, a vibration component is provided in each of the output seat 2 and the connecting seat 6. The beneficial effect of such an arrangement is that, through such an arrangement, the massage output effect is further improved, so that the effect of relaxation and therapy is better, and the overall effectiveness is improved; in addition, the structure is reliable in configuration; and the vibration components are provided, respectively, so that mutual interference can be avoided, improving the effectiveness of the structure, thereby allowing a user to experience an excellent usage effect.

As a further arrangement of this embodiment, the vibration component includes a mounting seat 51, a vibration motor 52, and a mass block 53, the mounting seat 51 is correspondingly provided in the connecting seat 6 and the output seat 2, the vibration motor 52 is provided on the mounting seat 51, and an output end of the vibration motor 52 is connected to the mass block 53. The beneficial effect of such an arrangement is that, through such an arrangement, the structure is simple, vibration output is reliable, and installation is stable, facilitating modular production and assembly, thereby improving production and manufacturing efficiency and achieving an excellent usage effect.

As a further arrangement of this embodiment, outer walls of the connecting seat 6, the grip handle 1 and the output seat 2 are covered with a continuous soft cushion 7. The beneficial effect of such an arrangement is that, through such an arrangement, the overall comfort of the structure during use is enhanced, the usage effect is improved, and the simple structure is easy to implement.

As a further arrangement of this embodiment, a surrounding frame 11 is provided in the grip handle 1, and the driving motor 3 is provided in the surrounding frame 11. The beneficial effect of such an arrangement is that, through such an arrangement, the position stability of the driving motor 3 is ensured, preventing the structure from deviating due to vibrations, thereby improving the usage reliability of the structure.

The above examples are merely preferred specific embodiments of the present disclosure. Any usual variations and substitutions made by those skilled in the art within the scope of the technical solutions of the present disclosure are included within the protection scope of the present disclosure.

What is claimed is:

1. A multi-directional massage output device, comprising a grip handle, wherein the grip handle is provided with an output seat, a driving motor is provided on the grip handle, an output end of the driving motor is connected to a connecting member, the connecting member comprises a connecting portion and an inclined crank arm, the crank arm is connected to the output seat, and the connecting portion is connected to the output end of the driving motor.

2. The multi-directional massage output device according to claim 1, wherein the grip handle is provided in an S-shape, and the output seat is provided at an end of the grip handle.

3. The multi-directional massage output device according to claim 1, wherein the grip handle is provided in an S-shape, the output seat is positioned in the middle of the grip handle, a connecting seat is provided at an end of the grip handle, and a vibration component is provided in the connecting seat.

4. The multi-directional massage output device according to claim 3, wherein the connecting seat extends toward an output shaft, and a spacing groove is formed between the output seat and the connecting seat.

5. The multi-directional massage output device according to claim 1, wherein the connecting portion of the connecting member and the crank arm are connected via a transition block, and the transition block is provided as a spherical fan shape.

6. The multi-directional massage output device according to claim 3, wherein a vibration component is provided in each of the output seat and the connecting seat.

7. The multi-directional massage output device according to claim 6, wherein the vibration component comprises a mounting seat, a vibration motor, and a mass block, the mounting seat is correspondingly provided in the connecting seat and the output seat, the vibration motor is provided on the mounting seat, and an output end of the vibration motor is connected to the mass block.

8. The multi-directional massage output device according to claim 3, wherein outer walls of the connecting seat, the grip handle and the output seat are covered with a continuous soft cushion.

9. The multi-directional massage output device according to claim 1, wherein a surrounding frame is provided in the grip handle, and the driving motor is provided in the surrounding frame.
